(19) United States
(12) Patent Application Publication
(10) Pub. No.: US 2008/0225423 A1
(43) Pub. Date: Sep. 18, 2008

(54) FILTER AND PLASMA DISPLAY APPARATUS INCLUDING THE SAME

(75) Inventors: Sang-Yeol Hur, Suwon-si (KR); Myun-Gi Shim, Suwon-si (KR); Dong-Gun Moon, Suwon-si (KR); Jun-Kyu Cha, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/041,104

(22) Filed: Mar. 3, 2008

(30) Foreign Application Priority Data
Mar. 12, 2007 (KR) 2007-24190

(51) Int. Cl. G02B 5/22; G02B 1/11

(52) U.S. Cl. 359/890

(57) ABSTRACT

A filter to improve contrast and shield electromagnetic waves, and a plasma display apparatus including the filter. The filter includes a base film, a first color pattern unit having strips disposed in parallel, at predetermined intervals, on both surfaces of the base film, and a second color pattern unit formed on one or both of the surfaces of the base film. The first color pattern unit and the second color pattern unit are conductive, and intersects one another.

### CROSS-REFERENCE TO RELATED APPLICATION

This application claims the benefit of Korean Application No. 2007-24190, filed Mar. 12, 2007, in the Korean Intellectual Property Office, the disclosure of which is incorporated herein by reference.

### BACKGROUND OF THE INVENTION

1. Field of the Invention

Aspects of the present invention relate to a filter and a plasma display apparatus including the filter, and more particularly, to a filter that can improve contrast and shield electromagnetic waves.

2. Description of the Related Art

Plasma display apparatuses are flat panel displays that use a gas discharge to display images, and have excellent brightness, contrast, residual image resistance, and viewing angle. Plasma display apparatuses have large screens that are thin and lightweight. Therefore, plasma display apparatuses are considered to be the next generation of large, flat panel, display apparatuses.

In a conventional plasma display panel (PDP), discharge electrodes, each including a pair of transparent X and Y electrodes, corresponding to display electrodes, are formed on the inner surface of a front glass substrate. Address electrodes are formed on the inner surface of a rear glass substrate. A sustain discharge occurs between the X and Y electrodes during operation of the PDP. When a plasma display apparatus is driven, external light is incident to the plasma display apparatus. The incident external light may be reflected. The contrast of the plasma display apparatus is reduced by the reflected external light, thus limiting image quality.

In addition, when a plasma display apparatus is driven, electromagnetic waves are emitted from the plasma display apparatus. The electromagnetic waves are harmful to human beings, and may interfere with electronic components of the plasma display apparatus.

### SUMMARY OF THE INVENTION

Aspects of the present invention provide a filter capable of improving the contrast of and shielding electromagnetic waves emitted by, a plasma display apparatus.

According to aspects of the present invention, a filter and a plasma display including the filter are provided. The filter includes: a base film; a first color pattern unit including a plurality of strips disposed at predetermined intervals and extending in a substantially parallel orientation on both surfaces of the base film; and a second color pattern unit, including a plurality of strips, formed on one surface of the base film. The first color pattern unit and the second color pattern unit are conductive, and the second color pattern unit intersects the first color pattern unit.

The strips of the first color pattern unit, disposed on each side of the base film, may completely overlap one another when viewed along an axis perpendicular to each surface of the base film. The widths of the strips of the second color pattern unit may be less than the widths of the strips of the first color pattern unit. Each of the first color pattern unit and the second color pattern unit may include a conductive metal. The conductive metal may be one selected from the group consisting of Ti, Cu, Ni, Mn, Cr, Fe, Ag, and Al. Each of the first color pattern unit and the second color pattern unit may include conductive carbon black. Each of the first color pattern unit and the second color pattern unit can comprise an azo-based metal compound.

The width of the strips of the first color pattern unit may be in a range of about 1 to 200 micrometers. The thickness of the strips of the first color pattern unit may be in a range of about 0.001 to 200 micrometers. The strips of the first color pattern unit may be spaced apart at an interval in a range of about 1 to 300 micrometers. The strips of the second color pattern unit may be spaced apart at an interval in a range of about 1 to 100 micrometers. The interval of the strips of the second color pattern unit may be in a range of about 1 to 500 micrometers.

The filter may further include a reflection prevention layer disposed adjacent to the first color pattern unit. The filter may further include an adhesion layer interposed between the first color pattern unit and the reflection prevention (antiglare) layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic exploded perspective view of a filter, according to an exemplary embodiment of the present invention;

FIG. 2 is a schematic plane view illustrating the distribution of first and second color pattern units of FIG. 1, according to an exemplary embodiment of the present invention;

FIG. 3 is a cross-sectional view of the filter taken along line III-III of FIG. 1;

FIG. 4 is a cross-sectional view of the filter taken along line IV-IV of FIG. 1;

FIG. 5 is a cross-sectional view of a filter, according to another exemplary embodiment of the present invention;

FIG. 6 is a schematic cross-sectional view of a filter, according to another exemplary embodiment of the present invention;

FIG. 7 is a schematic exploded perspective view of a plasma display apparatus including a filter, according to an exemplary embodiment of the present invention; and

FIG. 8 is a cross-sectional view of the plasma display apparatus taken along line VIII-VIII of FIG. 7.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

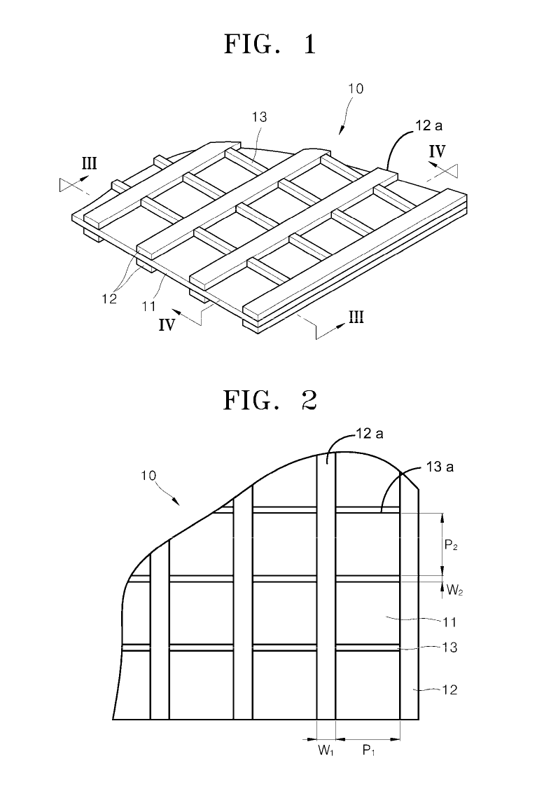

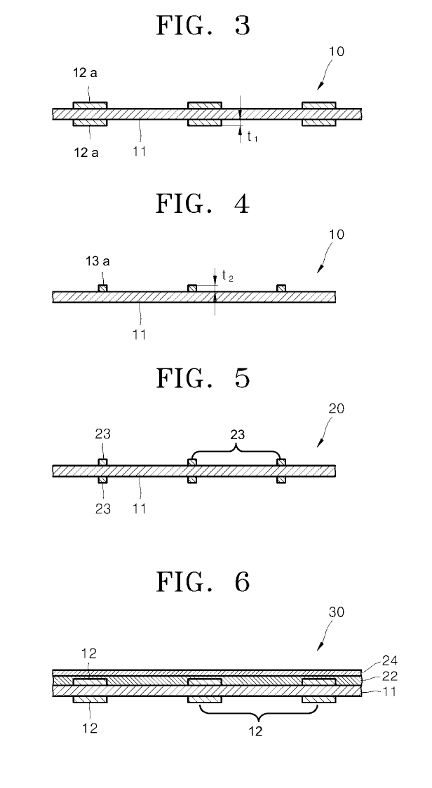

FIG. 1 is a schematic exploded perspective view of a filter 10, according to an exemplary embodiment of the present invention. FIG. 2 is a schematic plane view illustrating the distribution of first and second color pattern units 12 and 13 of FIG. 1, according to an exemplary embodiment of the present invention FIG. 3 is a partial cross-sectional view of the filter 10 taken along line III-III of FIG. 1. FIG. 4 is a partially cross-sectional view of the filter 10 taken along line IV-IV of FIG. 1.

The filter 10 includes a base film 11, a first color pattern unit 12, and a second color pattern unit 13. The base film 11 may be formed of a transparent material that can transmit visible light. The base film 11 can be tinted in order to improve contrast or to improve a color temperature. Adjusting the tint of the base film 11 can control the transmittance of visible light. The base film 11 can be formed of, for example, polyethersulphone (PES), polyacrylate (PAR), polyetherimide (PEI), polyethyelenen napthalate (PEN), polyethyeleneterepthalate (PET), polyphenylene sulfide (PPS), polyallylate, polyimide, polycarbonate (PC), cellulose tri-acetate (TAC), or cellulose acetate propionate (CAP). The base film 11 may be formed as a flat plate and have a thickness in a range of about 10 to 500 micrometers.

The first color pattern unit 12 is formed on both upper and lower (first and second) surfaces of the base film 11. The first color pattern unit 12 is formed of strips 12a disposed at predetermined intervals. The strips 12a extend in parallel to one another and can be, for example, in a striped pattern. The first color pattern unit 12 may be formed of a material having high absorbance of visible light, and particularly, may have a black color having low brightness and saturation. Although not illustrated, an oxide layer may be formed on the first color pattern unit 12. The oxide layer can be a thin film of a light absorbing material, which is disposed on the surface of the first color pattern unit 12. The first color pattern unit 12 may be conductive. In order to have conductivity, the first color pattern unit 12 may include a conductive metal. The conductive metal may include any one selected from the group Ti, Cu, Ni, Mn, Cr, Fe, Ag, and Al. For example, the first color pattern unit 12 may be formed of TiO, CuO, NiO, MnO₂, Cr₂O₃, Fe₂O3, or the like. The first color pattern unit 12 may include conductive carbon black or an azo-based metal compound. When the first color pattern unit 12 is conductive, the filter 10 may also function as an electromagnetic wave shielding layer.

The strips 12a of the first color pattern unit 12 have a width w1 in a range of about 1 to 200 micrometers. A smaller width w1 can increase transmissivity, but can also reduce an electromagnetic shielding effect and a contrast improving effect. A larger width w1 can increase the electromagnetic shielding effect and the contrast improving effect, but also can reduce the transmissivity. Accordingly, the width w1 of the first color pattern unit 12 is appropriately determined, according to particular process conditions.

The strips 12a of first color pattern unit 12 may have a thickness t1 in a range of about 0.001 to 200 micrometers. When the thickness t1 is reduced, the total thickness of the filter 10 is reduced, allowing a display apparatus, to which the filter 10 is attached, to be thinner, i.e., a thin film. However, reducing the thickness t1 can also reduce the electromagnetic shielding effect and the contrast improving effect. When the thickness t2 is increased, the first color pattern unit 12 can be more easily manufactured, and the electromagnetic shielding effect and the contrast improving effect can be improved. However, increasing the thickness t1 can also increase the total thickness of the filter 10, and when a reflection prevention layer, or the like, is formed on the filter 10, coherence may be reduced.

The strips 12a of first color pattern unit 12 are disposed at an interval p1. The interval p1 may be in a range of about 1 to 300 micrometers. Since the transmissivity can be reduced when the interval p1 is excessively small, the interval p1 is generally about 1 micrometer or more. Since the electromagnetic shielding effect and the contrast improving effect can be reduced when the interval p1 is excessively large, the interval p1 is generally about 300 micrometers or less.

A second color pattern unit 13 is formed on one of two surfaces of the base film 11. The second color pattern unit 13 intersects the first color pattern unit 12. The second color pattern unit 13 can comprise a number of strips 13a. The second color pattern unit 13 may be conductive. In order to have conductivity, the second color pattern unit 13 may be formed of a material including a conductive metal, particularly, one selected from the group consisting of Ti, Cu, Ni, Mn, Cr, Fe, Ag, and Al. For example, the second color pattern unit 13 may be formed of TiO, CuO, NiO, MnO₂, Cr₂O₃, Fe₂O3, or the like. The second color pattern unit 13 may be formed of conductive carbon black or an azo-based metal compound. When the second color pattern unit 13 is conductive, the filter 10 can shield electromagnetic waves.

The width w2 of the strips 13a of the second color pattern unit 13 may be less than or equal to the width w1 of the strips 12a of the first color pattern unit 12. The width w2 can be in a range of about 1 to 100 micrometers. Since the electromagnetic shielding effect and the contrast improving effect can be reduced when the width w2 is excessively small, the width w2 is generally about 1 micrometer or more. Since the transmissivity can be reduced when the width w2 is excessively large, the width w2 is generally about 100 micrometers or less.

The strips 13a of the second color pattern unit 13 are disposed at an interval p2. The interval p2 may be in a range of about 1 to 500 micrometers. Since the transmissivity can be reduced when the interval p2 is excessively small, the interval p2 is generally about 1 micrometer or more. Since the electromagnetic shielding effect and the contrast improving effect can be reduced when the interval p2 is excessively large, the interval p2 is generally about 500 micrometers or less.

The strips 13a of the second color pattern unit 13 have a thickness t2 in a range of about 0.001 to 200 micrometers. Since the total thickness of the filter 10 is reduced when the thickness t2 is reduced, a display apparatus including the filter 10 can be thinner, i.e. a thin film. However, reducing the thickness t2 can reduce the electromagnetic shielding effect and the contrast improving effect. When the thickness t2 is increased, the second color pattern unit 13 can be more easily manufactured, and the electromagnetic shielding effect and the contrast improving effect can be improved. However, increasing the thickness t2 can also increase the total thickness of the filter 10, and when a reflection preventing layer or the like is formed on the filter 10, the coherence may be reduced.

When the first color pattern unit 12 is formed on both surfaces of the base film 11, the reflection of external light is reduced, as compared to when the first color pattern unit 12 is formed on only one surface of the base film 11 However, such a dual surface configuration can shield visible light generated by a display apparatus to which the filter 10 is attached. To solve this problem, the portions of first color pattern unit 12, on each surface of the base film 11, may have the same pattern so as to be disposed on corresponding regions of upper and lower surfaces. In other words, when viewed along an axis perpendicular to either surface of the base film 11, the strips 12a disposed on one side of the base film 11 completely overlap the strips disposed on the other side of the base film 11. The axis can be parallel to the flow direction of the visible light moving through the filter 10.

The first color pattern unit 12 and the second color pattern unit 13 are conductive and can shield electromagnetic waves. In addition, since the first color pattern unit 12 and the second color pattern unit 13 intersect each other, as illustrated in FIG. 2, the electromagnetic shielding effect can be improved. However, the second color pattern unit 13 can block visible rays generated by a display apparatus. Accordingly, the second color pattern unit 13 may be formed of fine wires, so that the width of the strips 13a of second color pattern unit 13 may be less than the width of the strips 12a of the first color pattern unit 12.

The operation of the filter 10 will now be described. When external light is incident on one surface of the filter 10, the first color pattern unit 12 absorbs and blocks the visible external light. In particular, since the first color pattern unit 12 is disposed on both surfaces of the base film 11, the effect for preventing reflection of external light is improved. The reflection of external light is effectively prevented and contrast is improved. The second color pattern unit 13 intersects the first color pattern unit 12, and the first color pattern unit 12, and the second color pattern unit 13 are conductive, to improve electromagnetic wave shielding effect.

As referred to herein, when an element is said to be disposed “on” or formed “on” another element, the elements can be positioned in direct contact with one another, or one or more intervening layers can be positioned between the elements. For example, a layer, such as an adhesion layer, can be disposed between the first and/or second color pattern units 12 and 13, and the base film 11.

FIG. 5 is a cross-sectional view of a filter 20, according to another exemplary embodiment of the present invention. Hereinafter, the differences between the embodiments of FIG. 5 and FIG. 1 will be described. Like reference numerals denote like elements in the drawings.

The filter 20 includes a base film 11, a first color pattern unit (not shown), and a second color pattern unit 23. The second color pattern unit 23 includes a number of strips 23a, and is formed on first and second surfaces of the base film 11, unlike the filter 10 of FIG. 4. The second color pattern unit 23 is formed to intersect the first color pattern unit. The second color pattern unit 23 is formed on both sides of the base film 11, and thus, the electromagnetic shielding effect can be improved. The strips 23a of the second color pattern unit 23 are disposed on each side of the base film 11, such that they completely overlap one another, when viewed along a reference line perpendicular to the surfaces of the base film 11. The reference line can be parallel to a flow direction of the visible light moving through the filter 20. The strips 23a can be perpendicular to the strips 12a. The strips 23a can intersect the strips 12a.

FIG. 6 is a schematic cross-sectional view of a filter 30, according to another exemplary embodiment of the present invention. The filter 30 includes a base film 11, a first color pattern unit 12, a second color pattern unit (not shown), and an antiglare layer 24. The antiglare layer 24 may include a hard, coating material. When the filter 30 is used, an external surface thereof may be damaged by an external force. Accordingly, the antiglare layer 24 includes the hard, coating material, to prevent scratches and other damage. The hard, coating material may include a polymer as a binder. The polymer may be acryl based, urethane based, epoxy based, or siloxane based. Alternatively, an ultraviolet curing resin, such as an oligomer, may be used as the polymer. In order to improve hardness, the hard, coating material may include a silica-based filler. If the antiglare layer 24 does not include the hard, coating material, an additional hard, coating layer may be formed on the antiglare layer 24.

The antiglare layer 24 may have a thickness in a range of about 2.0 to 7.0 μm, a hardness in a range of about 2 to 3 H, and a haze in a range of about 1.0 to 3.0%, however, the aspects of the present invention are not limited thereto.

An adhesion layer 22 is interposed between the first color pattern unit 12 and the antiglare layer 24. The adhesion layer 22 improves a coherence between the layers, that is, between the first color pattern unit 12 and the antiglare layer 24; and between the base film 11 and the antiglare layer 24.

The adhesion layer 22 may include a thermoplastic, UV-curing resin, for example, an acrylate-based resin or a pressure-sensitive adhesive (PSA). The adhesion layer 22 can be formed using a deep-coating method or using an air-knife method.

The adhesion layer 22 can further include a compound that is able to absorb near-infrared rays. The compound can be, for example, a resin including copper atoms, or a resin including a copper compound or a zinc compound. In addition, the adhesion layer 22 can include a pigment or a dye, for color correction. The pigment of the adhesion layer 22 selectively absorbs light within a wavelength range. The wavelength range can include visible light having a wavelength ranging from about 400 to 700 nm. In particular, when a discharge occurs in the plasma display panel, undesirable visible light having a wavelength of about 585 nm is emitted, due to Neon discharge gas. In order to absorb such visible light, the adhesion layer 14 can include a cyanine-based compound, a squarylium compound, an azomethine-based compound, a xanthene-based compound, an oxonole-based compound, or an azo-based compound.

Meanwhile, the filter 30 can selectively include at least one of an infrared ray shielding layer (not shown) and a color correction layer (not shown). The shielding from infrared rays can be achieved by the first and second color pattern units 12 and 13, or by the adhesion layer 22. The shielding, of the first and second color pattern units 12 and 13 or the adhesion layer 22, can be enhanced by an additional layer, if necessary. The color correction layer is used when the color purity of the visible light incident from the plasma display apparatus, to which the filter 30 of the present invention is applied, is low or when a color temperature needs to be corrected.

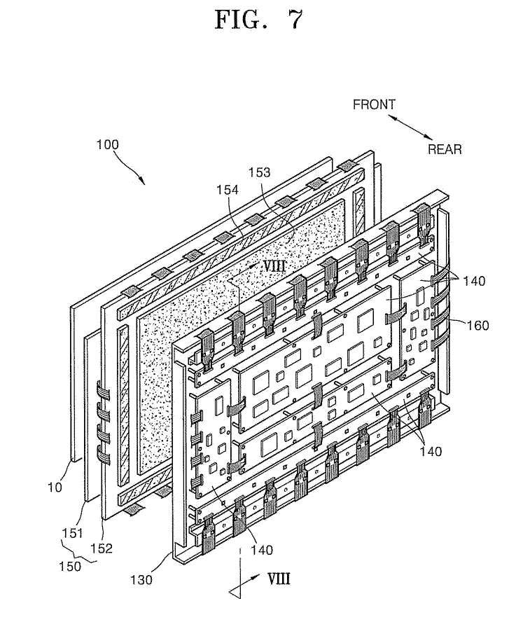

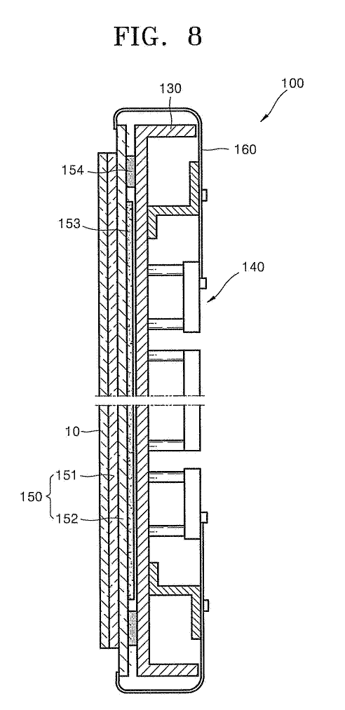

FIG. 7 is a schematic exploded perspective view of a plasma display apparatus 100 including a filter 10, according to an exemplary embodiment of the present invention. FIG. 8 is a cross-sectional view of the plasma display apparatus 100, taken along line VIII-VIII of FIG. 7.

The plasma display apparatus 100 includes a plasma display panel 150, a chassis base 130, and circuit units 140. The filter 10 is attached to a front surface of the plasma display panel 150.

The filter 10 may be attached to the front surface of the plasma display panel 150 by an adhesion layer (not shown). Although the filter 10 is illustrated in FIG. 7, the aspects of present invention are not limited thereto. That is, filters 20 and 30, according to other exemplary embodiments of the present invention, may be used.

Visible light, entering the filter 10 from the outside during the operation of the plasma display panel 150, is absorbed by the first color pattern unit 12, to improve contrast. When the first color pattern unit 12 is conductive, electromagnetic waves, generated during the operation of plasma display panel 150, are blocked. In particular, the plasma display apparatus 100 includes a conductive second color pattern unit 13 that intersects the first color pattern unit 12, and thus, electromagnetic waves can be blocked. Infrared rays or neon rays, can be blocked by the electromagnetic wave shielding layer 12 of the filter 10. Since the filter 10 is directly attached to the front surface of the plasma display panel 10, dual-image generation can be prevented. In addition, the filter 10 has a lighter weight than a conventional tempered glass filter, and is cheaper to fabricate.

The plasma display panel 150 includes a front panel 151 and a rear panel 152, to display images, which face each other and are coupled together. On the front panel 151 and the rear panel 152, a plurality of electrodes, to which voltages are applied, are arranged. The electrodes on the front panel 151 and the rear panel 152 may be covered by a dielectric layer. Barrier ribs, defining a plurality of discharge cells in which a discharge occurs, are formed between the front panel 151 and the rear panel 152. Red, green, and blue phosphor materials are applied on the barrier ribs. In addition, a discharge gas, such as Xe, is filled in the discharge cells. The chassis base 130 is installed on a rear portion of the plasma display panel 150.

The chassis base 130 supports the plasma display panel 150 and is coupled to the plasma display panel 150 by an adhesive, for example, a dual-adhesive tape 154. The chassis base 130 also dissipates heat generated by the plasma display panel 150. The chassis base 130 can be formed of a material having a high heat dissipating property, for example aluminum. The chassis base 130 can be fabricated by casting or pressing.

A thermal transfer medium 153, such as a heat conductive sheet, is inserted between the plasma display panel 150 and the chassis base 130. The thermal transfer medium 153 dissipates the heat generated by the plasma display panel 150, to prevent heat buildup when the plasma display apparatus 100 is driven. In addition, the thermal transfer medium 153 can sufficiently transfer heat from the plasma display panel 150 to the chassis base 130, and thus dissipate heat.

The circuit units 140 are installed on a rear portion of the chassis base 130. The circuit units 140 generate electrical signals for driving the plasma display panel 150 and transmit the electrical signals to the plasma display panel 150. A plurality of signal transmission units 160 are disposed between the circuit units 140 and the plasma display panel 150, to connect the circuit units 140 to the plasma display panel 150. The signal transmission units 160 electrically connect the circuit units 140 to the plasma display panel 150, and can be tape carrier packages or flexible printed cables, for example.

Electronic devices such as integrated circuits, which turn on/off the signal transmission from the circuit units 140 to the plasma display panel 150, can be mounted on the signal transmission units 160. The signal transmission units 160 can include tape-type wiring portions.

A cover plate (not shown) can be disposed on the rear surface of the chassis base 130, in order to cover the signal transmission units 160. The cover plate dissipates heat generated by the signal transmission units 160 and prevents the signal transmission units 160 from being damaged. The cover plate can be formed of a material including a metal.

The plasma display apparatus 100 having the filter 10 is exemplary, and the filter of the present invention can be attached to the front surfaces of various other kinds of display apparatuses. The filter, according to aspects of the present invention, and the plasma display apparatus including the filter, can improve contrast, and the electromagnetic waves emitted from the plasma display apparatus can be shielded.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A filter comprising:
a base film having a first surface and a second surface;
a first color pattern unit comprising a first plurality of strips disposed on the first surface of the base film and a second plurality of strips disposed on the second surface of the base film,
wherein the first plurality of strips are disposed substantially parallel and spaced apart from one another, and the second plurality of strips are disposed substantially parallel and spaced apart from one another; and
a second color pattern unit comprising a third plurality of strips disposed on the first surface of the base film and intersecting with the first plurality of strips,
wherein the first color pattern unit and the second color pattern unit are conductive.

2. The filter of claim 1, wherein the first and second pluralities of strips of the first color pattern unit are disposed to overlap one another when viewed along a reference line perpendicular to the first and second surfaces of the base film.

3. The filter of claim 1, wherein the strips of the first color pattern unit each have a first width and the strips of the second color pattern unit each have a second width that is less than the first width.

4. The filter of claim 1, wherein each of the first color pattern unit and the second color pattern units comprises a conductive metal.

5. The filter of claim 4, wherein the conductive metal is one selected from the group consisting of Ti, Cu, Ni, Mn, Cr, Fe, Ag, and Al.

6. The filter of claim 1, wherein each of the first color pattern unit and the second color pattern unit comprises conductive carbon black.

7. The filter of claim 1, wherein each of the first color pattern and the second color pattern comprises an azo-based metal compound.

8. The filter of claim 1, wherein each of the strips of the first color pattern unit has a width in the range of about 1 to 200 micrometers.

9. The filter of claim 1, wherein each of the strips of the first color pattern unit has a thickness in the range of about 0.001 to 200 micrometers.

10. The filter of claim 1, wherein the strips of the first color pattern unit are spaced apart at an interval in the range of about 1 to 300 micrometers.

11. The filter of claim 1, wherein each of the strips of the second color pattern unit has a width in the range of 1 to 100 micrometers.

12. The filter of claim 1, wherein the strips of the second color pattern unit are spaced apart at an interval in the range of about 1 to 500 micrometers.

13. The filter of claim 1, further comprising:
an antiglare layer disposed adjacent to and facing the first plurality of strips of the first color pattern unit.

14. The filter of claim 13, further comprising:
an adhesion layer disposed between the first plurality of strips of the first color pattern unit and the antiglare layer.

15. The filter of claim 1, wherein the second color pattern unit further comprises a fourth plurality of strips disposed on the second surface of the base film and intersecting the second plurality of strips of the first color pattern unit.

16. The filter of claim 15, wherein the fourth plurality of strips of the second color pattern unit are orthogonally disposed with respect to the second plurality of strips of the first color pattern unit.

17. The filter of claim 15, wherein the third and fourth pluralities of strips of the second color pattern unit are disposed to completely overlap one another when viewed along a reference line perpendicular to the first and second surfaces of the base film.

18. The filter of claim 1, wherein the third plurality of strips of the second color pattern unit are orthogonally disposed with respect to the first plurality of strips of the first color pattern unit.

19. A plasma display apparatus comprising the filter of claim 1.

20. A plasma display apparatus comprising the filter of claim 2.

21. A plasma display apparatus comprising the filter of claim 15.

22. A plasma display apparatus comprising the filter of claim 17.
